(19) United States
(12) Patent Application Publication
(10) Pub. No.: US 2014/0332645 A1
(43) Pub. Date: Nov. 13, 2014

(54) Decoy and Camera Stake

(71) Applicant: Kevin Brooks, Leitchfield, KY (US)

(72) Inventor: Kevin Brooks, Leitchfield, KY (US)

(21) Appl. No.: 13/998,981

(22) Filed: Dec. 30, 2013

Related U.S. Application Data
(60) Provisional application No. 61/848,248, filed on Dec. 29, 2012.
(60) Provisional application No. 61/848,252, filed on Dec. 29, 2012.
(60) Provisional application No. 61/848,253, filed on Dec. 29, 2012.
(60) Provisional application No. 61/855,853, filed on May 28, 2013.

(51) Int. Cl. A01M 31/06; F16M 11/04

(52) U.S. Cl. CPC A01M 31/06; F16M 11/04
USPC 248/156

(57) ABSTRACT

A stake which can be screwed into the ground to hold a device such as a water fowl decoy or a trail camera in position primarily for use out doors. The stake includes a helical coil at one end for fixedly and removably attaching that end of the stake into the ground by screwing the helical coil into the ground. The other end of the stake includes a receiver for removably and fixedly attaching a water fowl decoy such as a duck decoy or other elements such as a camera in cooperative engagement with the receiver on the top end of the stake. The stake includes an integral handle configured to manually turn the stake in order to screw the coiled end into the ground. One embodiment includes three outrigger legs for further stability.

### CROSS REFERENCE TO RELATED APPLICATIONS

This application claims priority from U.S. Provisional Application Ser. No. 61/848,248 filed on Dec. 29, 2012 and U.S. Provisional Application Ser. No. 61/848,252 filed on Dec. 29, 2012 and U.S. Provisional Application Ser. No. 61/848,253 filed on Dec. 29, 2012 and U.S. Provisional Application Ser. No. 61/855,583 filed on May 28, 2013 all of which are incorporated by reference herein in their entirety.

### TECHNICAL FIELD

The present invention relates to the field of stakes used to hold a water fowl decoy in position to attract ducks or geese or to hold a trail camera in position for use on an outdoor trail.

### BACKGROUND OF THE INVENTION

Duck hunters often use decoys for attracting ducks during a duck hunt. The decoys are typically displayed near or in the water and many are animated, that is, many decoys are provided with movable wings and heads which may or may not be motorized. Often times, decoys are attached to a pole or stake which holds the decoy in a preferred position which is likely to attract ducks. The decoy may be held above the water so that the motion of the wings gives the appearance of a duck landing on the water. Therefore, it is a requirement that the stake which holds the duck be firmly connected to the ground. Some decoy stakes have only one spiked end. Other decoy stakes have two or more parallel spikes which are shoved into the ground: a stout primary spike and lighter secondary parallel spikes which are simultaneously shoved into the ground. The stout spike gives the stake strength and rigidity and the lighter spikes provide further stability and prevent the stake from spinning in the ground.

Turkey hunters often use decoys for attracting turkeys. Often times, decoys are attached to a pole or stake which holds the decoy in a preferred position which is likely to attract turkeys. Moreover, the turkey decoy is moved via a jerk line to establish movement. Therefore, it is a requirement that the stake which holds the turkey decoy be firmly connected to the ground. Some decoy stakes have only one spiked end. Other decoy stakes have two spikes which are shoved into the ground: a stout primary spike and a lighter secondary parallel spike, the two spikes being simultaneously shoved into the ground. The double spikes gives the stake strength and rigidity and the lighter spike prevents the stake from spinning in the ground; however, depending upon whether the ground is hard and rocky it can be difficult to set the single or double prong stakes.

### DESCRIPTION OF THE RELATED ART

Stakes or poles for holding decoys, cameras and the like are available from numerous sporting goods outlets which are similar in form to the stakes described above. However, the applicant is unaware of any decoy stakes or trail camera holders which are available or any patents which include all of the elements and limitations of the herein described invention.

### SUMMARY OF THE INVENTION

In accordance with the present invention, there is provided a decoy/camera stake comprising, consisting of, or consisting essentially of an elongated rod having a helical coil formed at a bottom end thereof and an integral S-shaped crank handle formed therein above the helical coil. The rod is adjustable in length and male threads at a top end thereof. The threads have a diameter of one quarter inch and a pitch of 20 threads per inch. When compared to a stake with one or more spikes to be driven into the ground for support, a helical coil is a superior form of attachment to the ground for a decoy stake. A stake screwed into soil provides a more stable anchor than a straight shaft of the same length engaging the ground. Moreover, the area around a duck blind used by hunters is likely to be swampy or in a shallow lake or pond where the ground is muddy and soft. Sticking a spike into mud does not provide as secure support as a connection made by screwing in a helical coil, even in the mud. It is an object of this invention to provide a duck decoy stake which includes a helical coil at one end which can be screwed into the ground. It is an object of this invention to provide a duck decoy stake which includes a integral crank handle for the purpose of screwing the stake into the ground. It is an object of this invention to provide a duck decoy stake with helical coiled threads at one end and an opposite end which is square for receiving a duck decoy. It is an object of this invention to provide a duck decoy stake with a helical coil at one end and a crank handle which can be used to thread the coil into the ground, thus forming a rigid connection with the ground and providing secure support for a decoy. It is an object of this invention to provide a duck decoy stake which also includes a loop for attaching a jerk line to the upper end of the decoy stake. It is an object of this invention to provide a duck decoy stake or pole with ¼ inch by 20 threads at the top end for holding a standard camera. It is an object of this invention to provide a duck decoy stake or pole with a receiver at the top end for holding a standard camera wherein the receiver includes rod portion with ¼ inch by 20 threads and the rod portion is adjustably attached to the top end of the stake so that the camera may be held at any desired angle.

In accordance with the present invention, there is provided a device comprising, consisting of, or consisting essentially of an elongated rod having a helical coil formed at a first end thereof and a lug at the second end thereof. The lug is capable of cooperatively engaging a lug receiver in a turkey decoy. The rod has a U-shaped handle formed therein within about five inches of the lug. The U-shaped handle is formed by bending the rod at a right angle and then, at a location about three inches from the right angle bend, bending the rod one hundred eighty degrees back onto itself, thus forming a U-shape, and then bending the rod at a right angle so that the axis of the rod above the U-shape and the axis of the rod below the U-shape are coaxial.

Moreover, there is provided a device comprising, consisting of, or consisting essentially of an elongated rod having a helical coil formed at a bottom end thereof and an end cap at a top distal end thereof The rod includes a crank handle formed therein by formation of a “U-shaped handle” near the top end of the decoy stake providing for a holding means to rotate the rod. The top end of the rod includes at least one transverse aperture formed therein about one inch below the top end of the stake and a second transverse aperture formed therein about two inches below the top end, a second transverse aperture contains a ring which is capable of holding a jerk line. It is contemplated that a plurality of transverse apertures can be drilled or formed within the stake to provide adjustable attachment of the decoy which are generally mounted onto a base comprising a round aperture member which fits in cooperative relationship with the top end cap of the rod. When compared to a stake with one or two spikes, a helical coil is a superior form of attachment to the ground for a decoy stake. A stake screwed into soil is more secure than a straight rod, particularly when a user is trying to fix a decoy stake to soil which may be muddy and soft. Sticking a spike into mud is not as secure as a connection made by screwing in a helical coil, even in the mud.

It is an object of this invention to provide a turkey decoy stake which includes a helical coil at one end which can be screwed into the ground. It is an object of this invention to provide a turkey decoy stake which includes a U-shaped integral handle for the purpose of screwing the stake into the ground. It is an object of this invention to provide a turkey decoy stake with helical coiled threads at one end and a lug at the opposite end for receiving a turkey decoy. It is an object of this invention to provide a turkey decoy stake with a helical coil at one end and an integral handle which can be used to thread the coil into the ground, thus forming a rigid connection with the ground and providing secure support for a decoy.

Other objects, features, and advantages of the invention will be apparent with the following detailed description taken in conjunction with the accompanying drawings showing a preferred embodiment of the invention.

### BRIEF DESCRIPTION OF THE DRAWINGS

A better understanding of the present invention will be had upon reference to the following description in conjunction with the accompanying drawings in which like numerals refer to like parts throughout the views wherein:

FIG. 1 is a front view of a one piece integral decoy stake including a crank handle;

FIG. 2 is a front view of a disassembled three piece decoy stake kit;

FIG. 3 is a front view of an assembled three piece decoy stake kit;

FIG. 4 is a front view of decoy fitted with a square receiver for mounting the decoy on a square ended decoy stake of the present invention;

FIG. 5 is front view of a decoy stake spinning wing adjustable pole including a square decoy receiver on the top end with an integrated horizontally disposed w-shaped handle disposed near the top end of the stake immediately beneath the decoy receiver supported by a steel rod having a coiled spiral auger on the distal end, wherein the longitudinal shaft comprises at least one outer section of tubing including holes corresponding with a corresponding sized an shaped inner section of the rod having holes and being slidably adjustable within the outer section;

FIG. 6 is a front view of a one piece decoy/camera stake “low profile turkey stake” including a threaded or smooth portion at the top end and a horizontal disposed S-shaped crank handle at the bottom of the stake above the helical coiled bottom end spiral auger;

FIG. 7 is a front view of a one piece decoy/camera stake having a trail camera attached to a threaded top end and an S-shaped crank handle located about half way up the length of the stake;

FIG. 8 is a front view of a two piece decoy/camera stake with a the crank handle located about half way up the stake;

FIG. 9 is a perspective view of a decoy/camera stake apparatus;

FIG. 10 is a front view of a top portion of a decoy/camera stake including an camera holding fixture;

FIG. 11 is a perspective view of an adjustable decoy/camera stake;

FIG. 12 is a front view of a decoy/camera stake including a decoy rest in the form of a sleeve with a disc stop means and a square conduit on the top distal end including a t-shaped member, an integrated horizontally disposed S-shaped handle, a steel support rod and a spiral auger on the distal end;

FIG. 13 is a perspective view of a decoy anchor stake;

FIG. 14 is a perspective view of a turkey decoy anchor stake;

FIG. 15 is a perspective view of a turkey decoy mounted on the decoy anchor stake of FIG. 14;

FIG. 16 is a front view of the one piece integral decoy stake;

FIG. 17 is a front view of a disassembled three piece decoy stake kit;

FIG. 18 is a front view of an assembled three piece decoy stake kit;

FIG. 19 is a front view of decoy fitted with a square receiver for mounting the decoy on a square ended decoy stake of the present invention;

FIG. 20 is a side view of a fowl decoy stake;

FIG. 21 is a front plan view of the fowl decoy stake of FIG. 20 including a handle and a mounting cap;

FIG. 22 is an enlarged perspective view of the cap of FIG. 21;

FIG. 23 is a perspective view o the fowl decoy stake and cap;

FIG. 24 is a side view of the camera adapter mounting on a stake;

FIG. 25 is an enlarged view of the camera adapter of FIG. 24;

FIG. 26 is a front view of the camera adapter and stake of FIG. 24;

FIG. 27 is a perspective view of the camera adapter and stake of FIG. 24;

FIG. 28 is a side view of the locking cam mechanism and stake;

FIG. 29 is a front view of the locking cam mechanism and stake of FIG. 28;

FIG. 30 is an enlarged view of the locking cam mechanism of FIG. 28;

FIG. 31 is perspective view of the locking cam mechanism and stake of FIG. 28;

FIG. 32 is a side view of the locking cam mechanism;

FIG. 33 is top view of the locking cam mechanism of FIG. 32;

FIG. 34 is front view of the locking cam mechanism of FIG. 32;

FIG. 35 is sectional rear view of the locking cam mechanism of FIG. 32;

FIG. 36 is a perspective view of the locking tube of the cam mechanism of FIG. 32; and

FIG. 37 is a perspective view of the cam mechanism of FIG. 32.

### DESCRIPTION OF THE PREFERRED EMBODIMENTS

In accordance with the present invention, there is provided a decoy stake which holds a duck decoy in position for attracting ducks during a duck hunt.

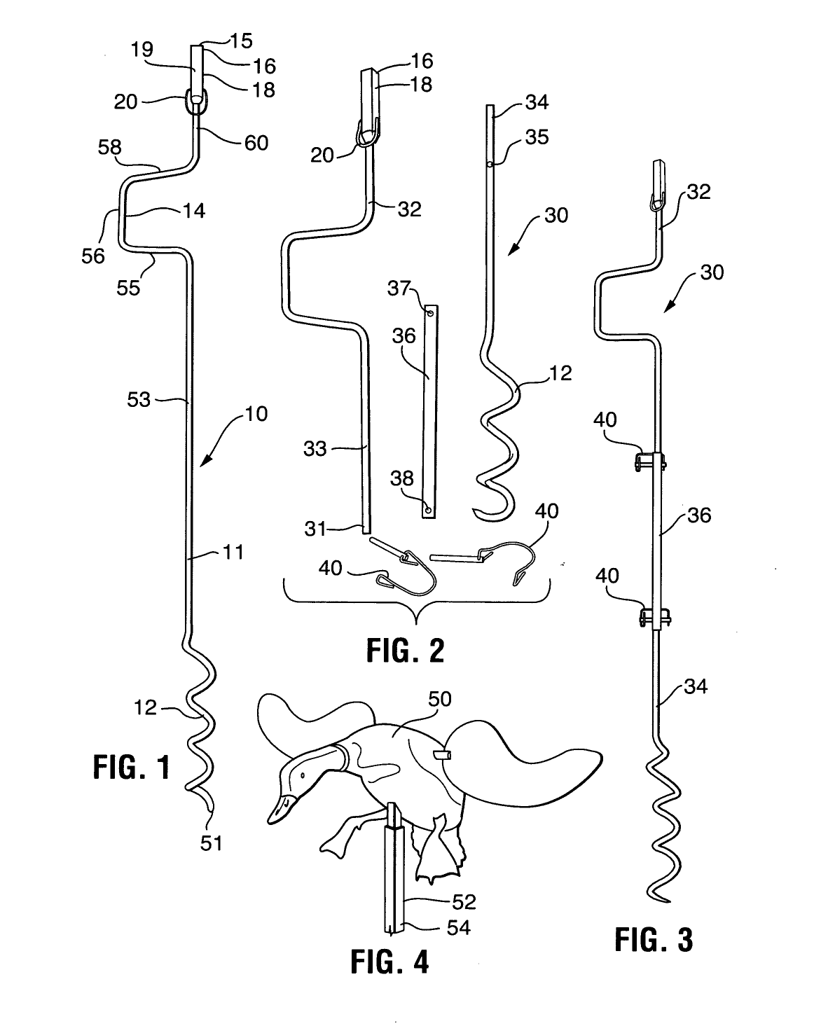

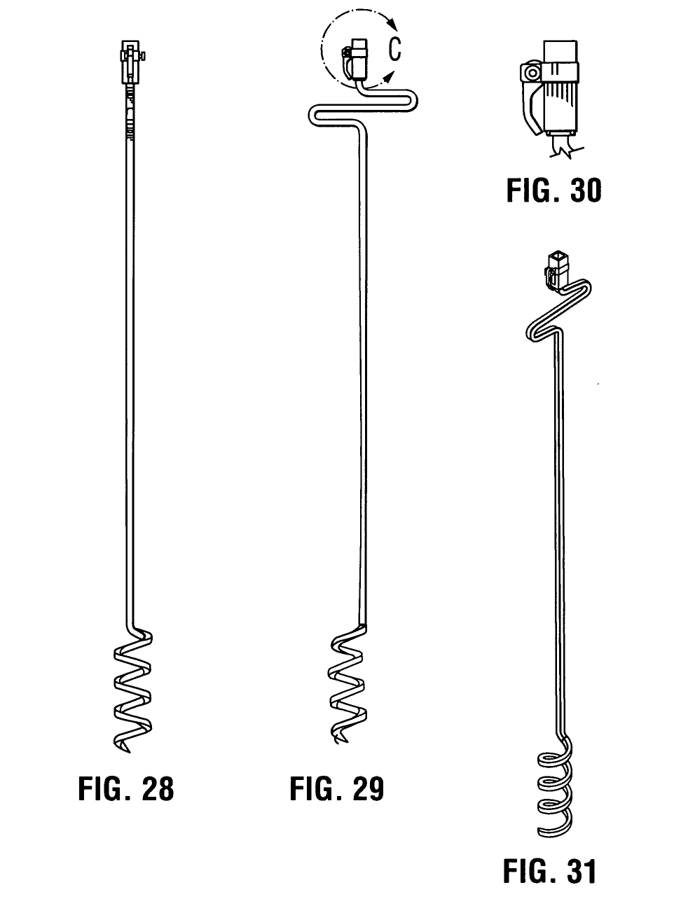

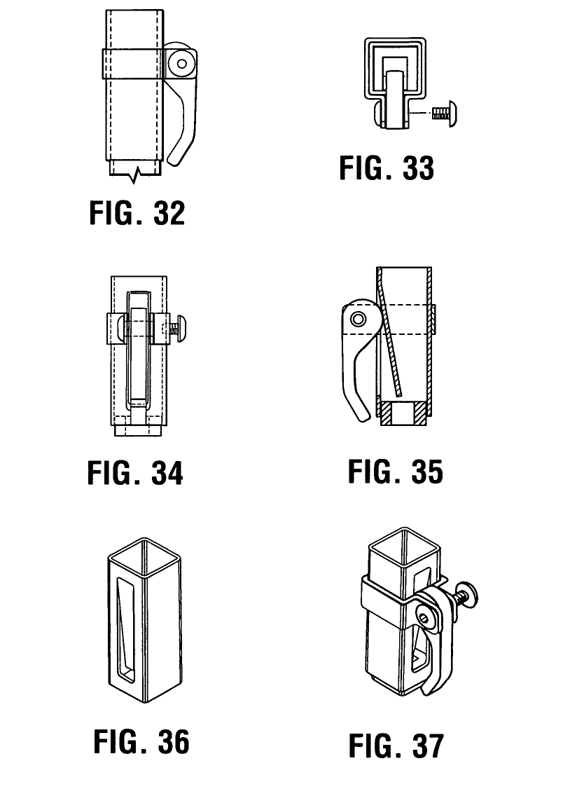

FIG. 1 shows a decoy stake 10 which includes an elongated shaft 11 which terminates at one end with a length of helical coil 12 and includes an elongated squared off shape 16 at the opposite distal end. The helical coil can be welded onto the end of a rod or fabricated by twisting the rod. The distal end of the rod typically includes a sharpened point 51 for piecing the ground. The medial portion of the stake 11 can be of any desired length; however, the stake is typically 1-3 feet long. An integral crank portion 14 is positioned above a selected length of the lower straight shank section 53. The crank 55 is formed by bending the rod at generally 90 degree angles (right angles), wherein a selected length of the rod or first crank section 55 is bent at outwardly horizontal to the ground at an angle from about 80 to 90 degrees, a second crank section 56 is bent upwardly vertical at an angle of between 80-90 degrees forming the handle portion. The rod is then bent inwardly at from 80-90 degrees horizontal with and parallel to the first crank section 55 forming a third crank section 58 with the outwardly bent portion in alignment therewith. The rod is then bent upwardly vertical to the ground at an angle of from 80-90 degrees in axial alignment with the lower portion of the rod 53 forming a top section 60. The top distal end of the top section 60 of the rod includes a squared off cross-section end 16 having a first transverse aperture 18 formed therein about one inch below the top end of the stake and a second transverse aperture formed therein about two inches below the top end, the second transverse aperture contains a ring which is capable of holding a jerk line. It is contemplated that a plurality of transverse apertures can be drilled or formed within the stake to provide adjustable attachment of the decoy which is generally mounted onto a base with a tubular square shaped member which fits in cooperative relationship with the top end 16 of the rod. As shown in FIGS. 28-37, a cam lock is shown which secures the rod or male fitting of a decoy, camera, or other mounted item within the female coupling at the distal end of the stake. The cam lock is shown having a square cross sectional area; however, it is contemplated that the cam lock is adaptable to cylindrical coupling units.

The transverse hole 18 near the tip 15 of the squared off end 16 is provided for insertion of a pin or keeper when the square hollow receiver 54 of the decoy 50 is installed on the squared end 16. Another transverse hole 19 contains a ring 20 for connection of a jerk line which a user may pull or jerk to cause the decoy stake to move.

After the stake 10 is screwed into the ground, the square hollow receiver 54 of a decoy 50, as shown in FIG. 4, is slipped over the square end 16 of the stake 10. The hole 52 in receiver 54 is aligned with the hole 18 in the square end 16 of the stake 10, and a lynch pin , such as shown in lynch pin 40 in FIG. 2, is slipped through to lock the decoy 50 into place on the stake 10. Thus a jerk line may be attached to a ring, such as a D-ring extending through the aperture or the line may be threaded through an aperture.

Another preferred embodiment of the present invention is shown in FIG. 2 and FIG. 3. The decoy stake 30 is contains a three part shaft including two round rods 33 and 34 and a tube 36 into which the rods 33 and 34 are slipped. The transverse hole 31 in rod 33 is aligned with the transverse hole 37 in the tube 36 and a lynch pin 40 is inserted therein. Likewise, the transverse hole 35 in rod 34 is brought into alignment with the transverse hole 38 of tube 36 and a lynch pin 40 is inserted therein. Thus assembled as shown in FIG. 3, the stake 30 can be used in the same way as the stake 10 is used. The disassembled three part shaft enables more compact storage of the stake 30 and also the capability of having an even longer assembled stake 30 depending on the size and number of rods and tubes and a plurality of transverse holes 38 located incrementally from a bottom end of tube 36. The three part nature of the stake 30 also facilitates transport in a back pack, or small case which is space saving.

The decoy stake can be formed in one integral piece by bending a single length of rod or can be formed by welding, brazing or using other means of securing the individual members together.

It is also contemplated that portions of the kit comprising the decoy stake may be fabricated from carbon fiber, fiberglass, or even molded from high density plastic in an integral form or individual sections.

It is further contemplated that a sleeve may be utilized in combination with the handle section 56.

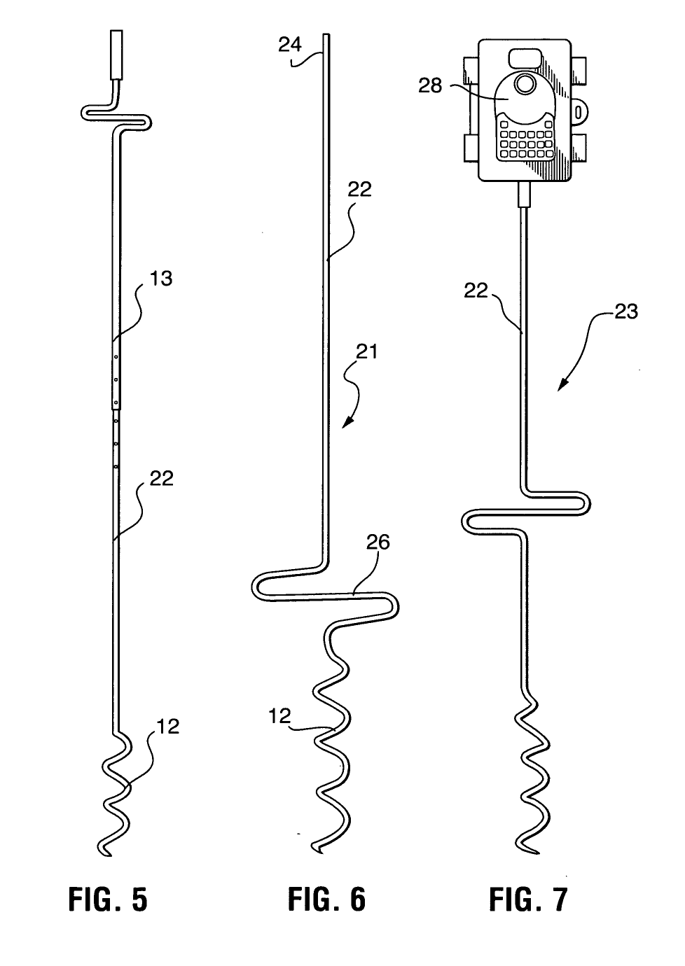

Further embodiments of the decoy/camera stake are shown in FIGS. 5-11 and include a variety of decoy/camera receiving fixtures at the top of the stake and an S-shaped crank handle located at various vertical positions between the tope end and the helical coiled bottom end.

A one piece decoy stake 13 shown in FIG. 5 includes a helical coil 12 at the bottom end, an upward extending longitudinal shaft 22, an integral S-shaped crank handle near the top end, and a square decoy receiver.

A one piece decoy/camera stake 21 shown in FIG. 6 includes a helical coil 12 at the bottom end, an integral S-shaped crank handle just above the helical coil, and an upward extending longitudinal shaft ending with a one quarter inch diameter end with threads spaced at 20 per inch or in other words, ‘quarter 20’ threads. This thread arrangement is capable of removably holding cameras with female quarter 20 threads integrated on the bottom of the camera. Decoys supplied with such threads can also be mounted on this threaded rod.

Another one piece decoy/camera stake 23 shown in FIG. 7 is the same as stake 21 in FIG. 6 except that the S-shaped crank handle is located in a central position along the length of the stake. Stake 23 is shown with a trail camera installed thereon.

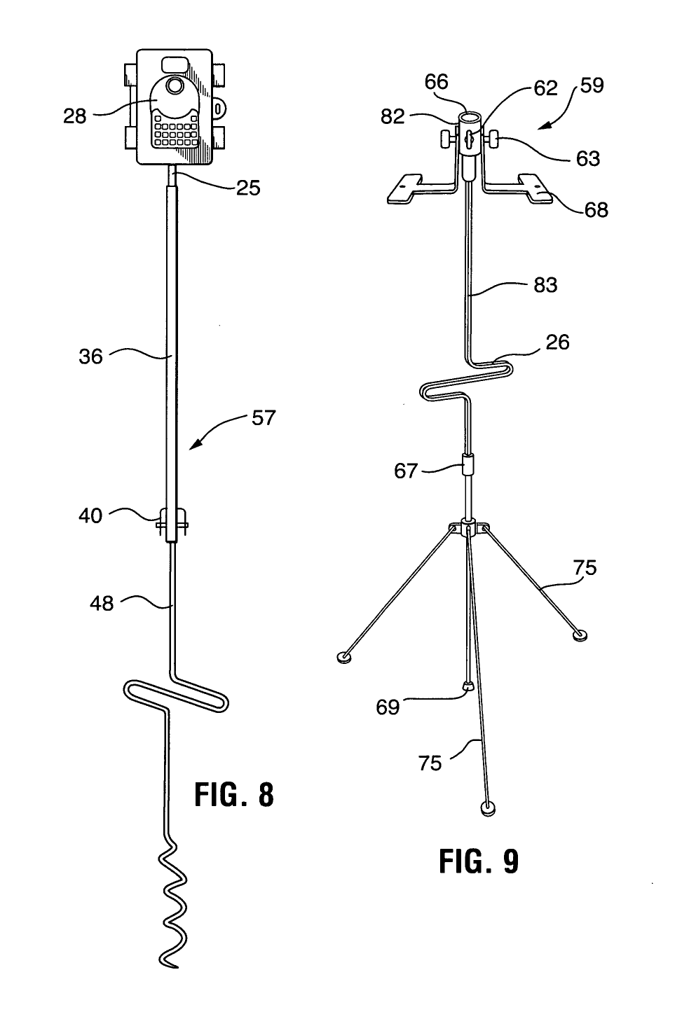

An adjustable two piece decoy/camera stake 57, shown in FIG. 8 includes an upper portion having a threaded top end 25 and a hollow pipe section 36 fixedly attached at the lower end with a plurality of transverse holes, one above another, for attaching a lower portion 48 of the stake, and a lower portion 48 which includes a helical coil, an S-shaped crank handle and a longitudinal top portion which is inserted into the hollow pipe section. The longitudinal top portion includes a transverse hole which is brought into alignment with a selected one of the plurality of transverse holes in the hollow pipe section. A lynch pin 40 is inserted into the aligned holes to hold the top portion to the lower portion. The selection of a particular one of the plurality of transverse holes in the hollow pipe section determines the length of the adjustable decoy/camera stake.

As best illustrated in FIG. 9, one preferred three piece adjustable decoy/camera stake apparatus 59 includes an upper longitudinal hollow pipe or sleeve portion 82 which is rotatably and supported by the distal end of upper rod section 83 and secured in a selected position by a wing nut set screw arrangement 62. The decoy/camera mounting fixture includes a pair of opposing horizontal T-shaped plates 68 for holding a camera thereon, mounted to the sleeve portion 82 by welding or other fastening means such as a second wing nut set screw arrangement 63. A horizontal disposed s-shaped crank handle 26 is integrally formed in the a lower portion of the upper rod section 83 which is removably and rotatably connected with a lower rod section 65 by an adjustable trail cam mount coupling device 64. It is contemplated that a receiver 66 for a decoy could be placed on the top of the sleeve 82. The lower rod portion 65 includes a integral spiral auger 69 extending from its distal end for anchoring the stake into the ground. A tripod assembly 74 includes a tripod adjustment means comprising a sliding and rotating sleeve or collar 67 slipped over the lower rod and secured with holding means such as a set screw arrangement at a selected position. A plurality of legs 75 extend downward at a selected acute angle from the collar to rest upon a supporting surface.

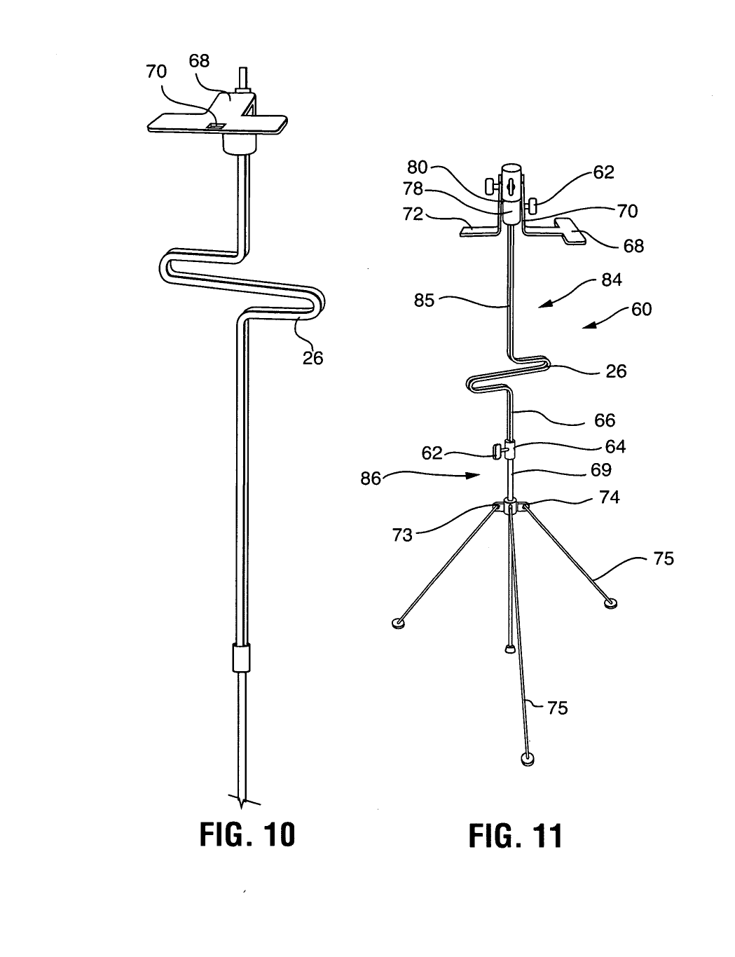

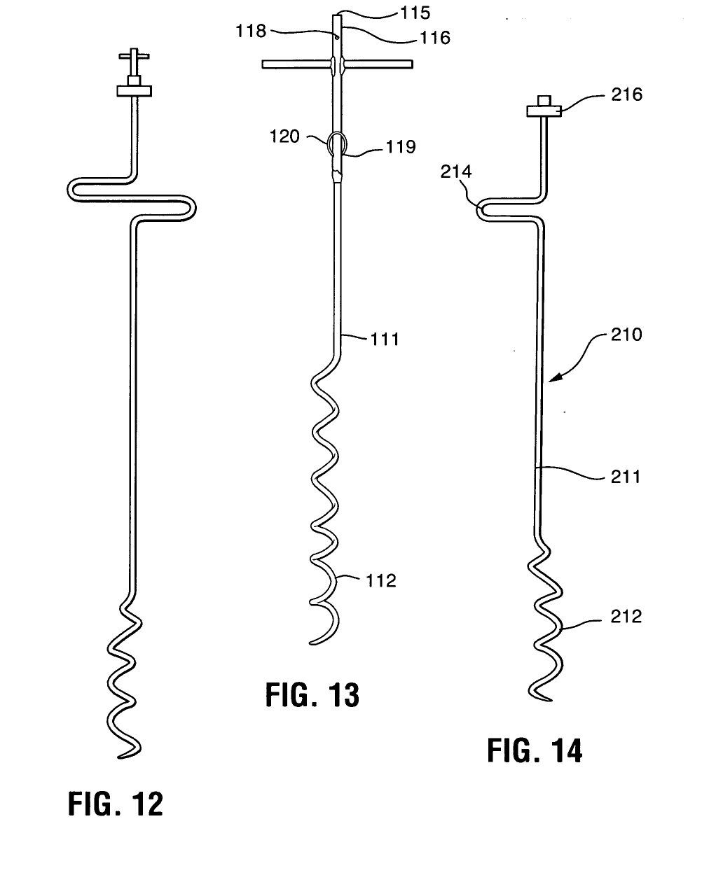

Another three piece adjustable decoy/camera stake 60 is shown in FIGS. 10 and 11. The stake 60 includes upper portion 84 with a longitudinal hollow pipe member 85 including an S-shaped crank handle 26, a clamp with thumbscrew 62 at the lower end and a spherical ball 78 at the upper end on which a decoy/camera mounting fixture 80 is adjustably held tight by thumbscrew 62. A lower portion 86 includes a longitudinal rod 69 held within an adjustable tripod 74 with a locking thumbscrew 73 and three legs 75. The longitudinal rod 69 has a helical coil (not shown in FIG. 11) at the lower end thereof. The decoy/camera mounting fixture includes a horizontal T-shaped plate 68 with an aperture 70 into which can be placed a quarter 20 screw which will then hold a camera or a decoy. A spherical ball and socket arrangement or clamp 78 camera mounting fixture 80 and thumbscrew 62 form a fixable or lockable ball joint which allows the camera mount 80 and therefore, the camera to be tilted at a wide range of vertical and horizontal angles with respect to the ground.

As shown in FIG. 13, a decoy stake 110 which includes an elongated shaft 111 which terminates at one end in the shape of a helical coil 112 and includes an elongated squared off shape 116 at the opposite distal end. The helical coil can be welded onto the end of a rod or fabricated by twisting the rod. The distal end of the rod typically includes a point 150 for piecing the ground. The medial portion 152 of the stake 111 can be of any desired length; however, it is typically 1-3 feet long. Decoy stake 110 also includes a T-handle 114 located near the square end 116 whereby a user can use the T-handle 114 while pressing the end of the helical coil 112 into the soil and can turn the T-handle 114 to cause the helical coil 112 to be threaded into the ground. Another transverse hole 119 contains a ring 120 for connection of a jerk line which a user may pull or jerk to cause the decoy stake to move, thus imparting motion to the decoy 150. After the stake 110 is screwed into the ground, the square hollow receiver 154 of a decoy 150 is slipped over the square end 116 of the stake 110. The hole 152 in receiver 154 is aligned with the hole 118 in the square end 116 of the stake 110, and a lynch pin is slipped through to lock the decoy 150 into place on the stake 110. The decoy stake can be formed in one integral piece by bending a single length of rod or it can be formed by welding, brazing or using other means of securing the individual members together. Another preferred embodiment of the present invention provides a decoy stake including a three part shaft including two rods and a tube into which the rods are cooperatively engaged. The transverse holes formed in the in rods are aligned with the transverse hole in the tube and a lynch pin is inserted therein. The transverse hole in the rod can be brought into alignment with the transverse hole of tube and a lynch pin inserted therein. The disassembled three part shaft enables more compact storage of the stake and also the capability of having and even longer assembled stake depending on the size and number of rods and tubes. It also facilitates transport in a back pack, or case which will fit into a luggage compartment. It is also contemplated that portions of the kit comprising the decoy stake may be fabricated from carbon fiber, fiberglass, or even molded from high density plastic in an integral form or individual sections. It is contemplated that the T-handle may be formed by hinged members which may be folded up and/or folded down against the longitudinal rod for storage or transportation.

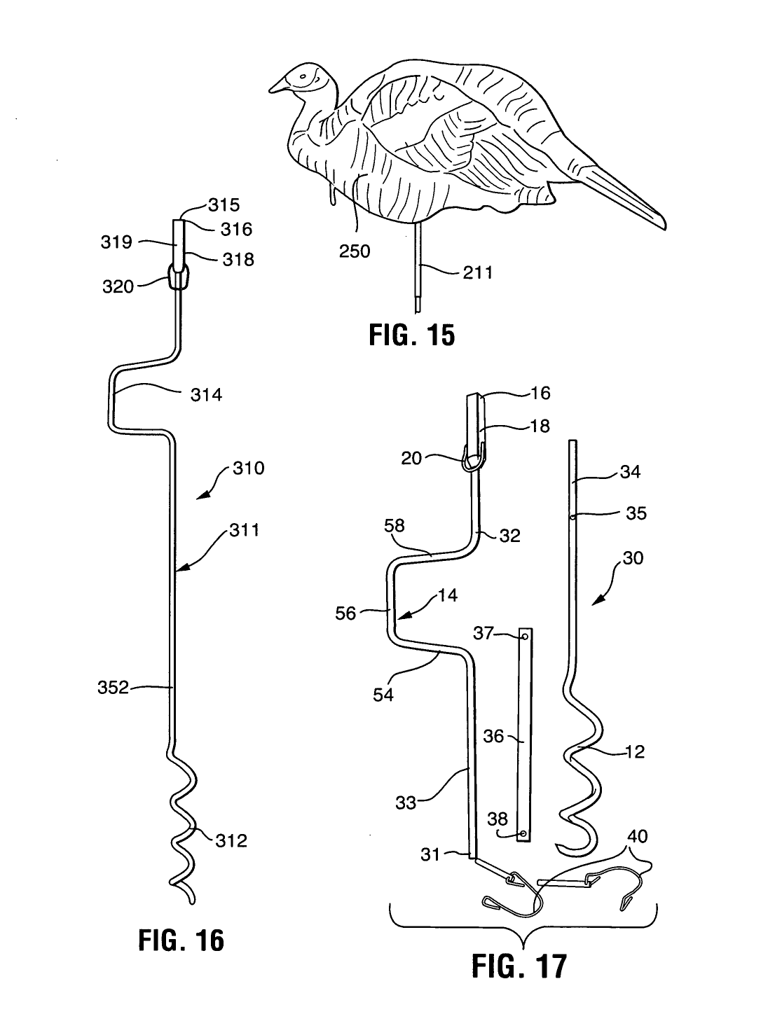

FIGS. 14-15 show a decoy stake 210 which includes an elongated shaft 211 which terminates at a point at the lower distal end and forms a spiral in the shape of a helical coil 212 which supports a turkey decoy holding lug at the other end cap. One preferred embodiment of the turkey decoy anchor 210 includes an integral U-shaped handle 214 at a selected location near the top of the end cap whereby a user can hold the rod with one hand and rotate the U-shaped handle 214 causing the end of the helical coil 212 to penetrate the soil rotating the helical coil 212 into the ground. After the stake 210 is screwed into the ground, the mounting lug receiver of a decoy 250 cooperatively engages the end cap 216 of the stake 210. In an alternate embodiment, the turkey decoy anchor includes an elongated shaft which terminates at one end in the shape of a helical coil and includes an annular end cap at the opposite distal end. The helical coil can be welded onto the end of a rod or fabricated by twisting the rod. The distal end of the rod typically includes a point for piecing the ground. The medial portion of the stake can be of any desired length; however, it is typically 1-3 feet long. An integral crank portion is positioned above a selected length of the lower straight shank section. The crank is formed by bending the rod at generally 90 degree angles (right angles), wherein a selected length of the rod or first crank section is bent at outwardly horizontal to the ground at an angle from about 80 to 90 degrees, a second crank section is bent upwardly vertical at an angle of between 80-90 degrees forming the handle portion. The rod is then bent inwardly at from 80-90 degrees horizontal with and parallel to the first crank section forming a third crank section with the outwardly bent portion in alignment therewith. The rod is then bent upwardly vertical to the ground at an angle of from 80-90 degrees in axial alignment with the lower portion of the rod forming a top section. The top distal end of the top section of the rod includes an annular end cap having a first transverse aperture formed therein about one inch below the top end of the stake and a second transverse aperture formed therein about two inches below the top end, the second transverse aperture contains a ring which is capable of holding a jerk line. It is contemplated that a plurality of transverse apertures can be drilled or formed within the stake to provide adjustable attachment of the decoy which are generally mounted onto a base with a tubular square shaped member which fits in cooperative relationship with the top end 16 of the rod. The transverse hole near the end cap is provided for insertion of a pin or keeper when the square hollow receiver of the decoy is installed on the end cap. Another transverse hole contains a ring for connection of a jerk line which a user may pull or jerk to cause the decoy stake to move. Another alternate embodiment of the present invention contains a three part shaft including a bottom spiral section, an intermediate section with the handle and a top section with the mounting end cap. The disassembled three part shaft enables more compact storage of the stake and also the capability of having and even longer assembled stake depending on the size and number of rods and tubes. It also facilitates transport in a back pack, or case which will fit into a luggage compartment. The decoy stake can be formed in one integral piece by bending a single length of rod or it can be formed by welding, brazing or using other means of securing the individual members together. It is contemplated that a sleeve may be utilized in combination with the handle section 56.

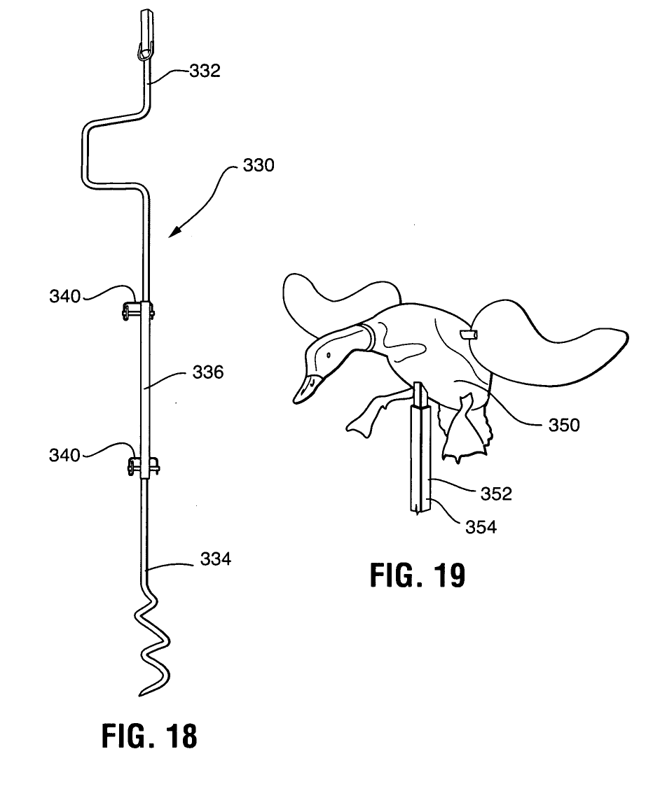

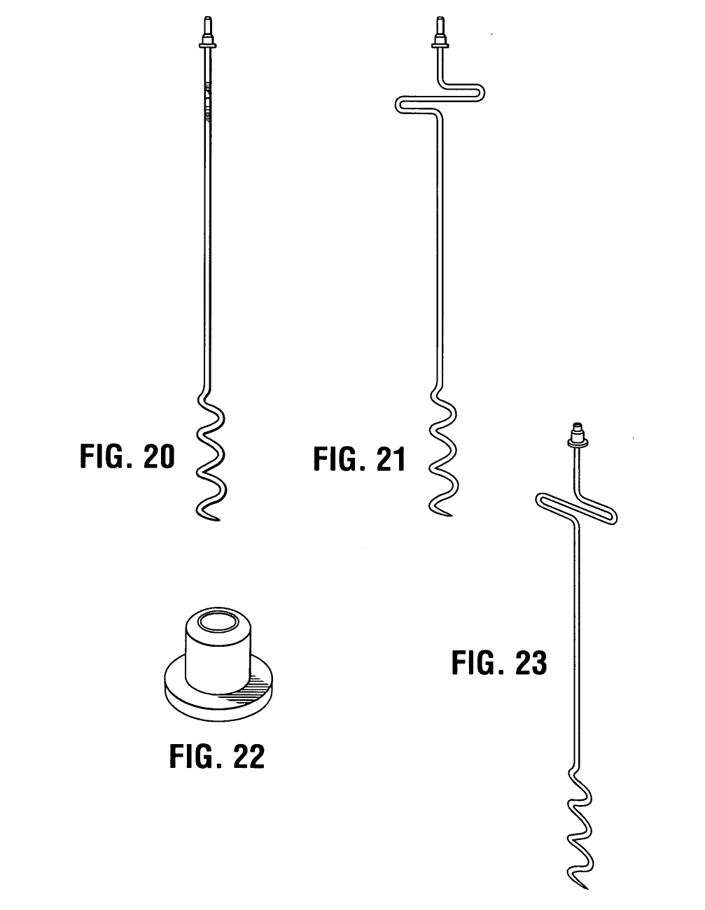

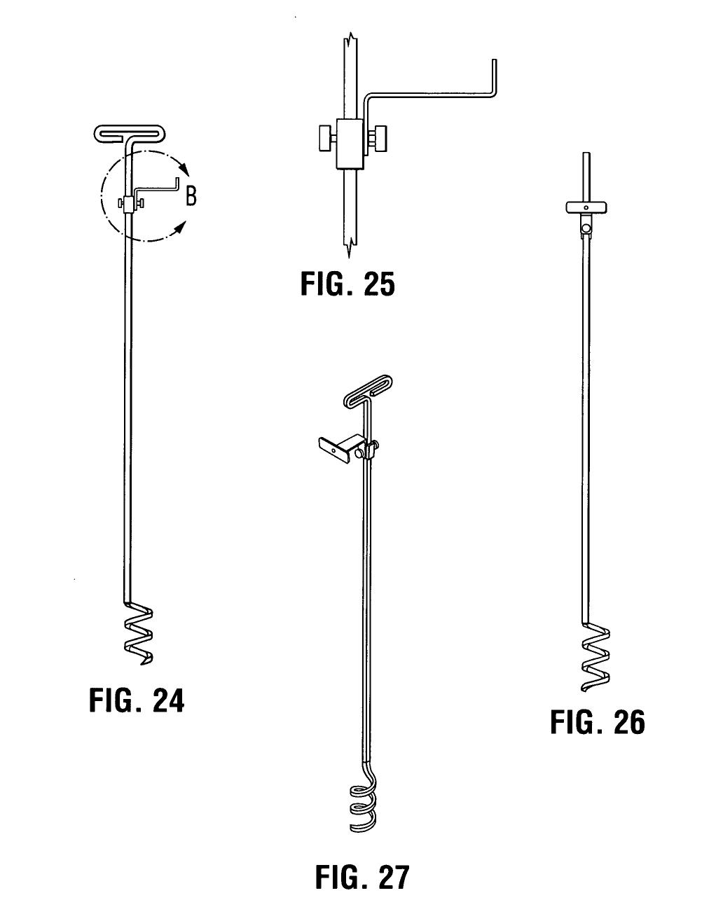

FIGS. 16-19 show a decoy stake 10 which includes an elongated shaft 311 which terminates at one end in the shape of a helical coil 312 and includes an elongated squared off shape 316 at the opposite distal end. The helical coil can be welded onto the end of a rod or fabricated by twisting the rod. The distal end of the rod typically includes a point 350 for piecing the ground. The medial portion 352 of the stake 311 can be of any desired length; however, it is typically 1-3 feet long. An integral crank portion 314 is positioned above a selected length of the lower straight shank section 352. The crank 354 is formed by bending the rod at generally 90 degree angles (right angles), wherein a selected length of the rod or first crank section 354 is bent at outwardly horizontal to the ground at an angle from about 80 to 90 degrees, a second crank section 356 is bent upwardly vertical at an angle of between 80-90 degrees forming the handle portion. The rod is then bent inwardly at from 80-90 degrees horizontal with and parallel to the first crank section 354 forming a third crank section 358 with the outwardly bent portion in alignment therewith. The rod is then bent upwardly vertical to the ground at an angle of from 80-90 degrees in axial alignment with the lower portion of the rod 333 forming a top section 360. The top distal end of the top section 360 of the rod includes a squared off cross-section end 316 having a first transverse aperture 318 formed therein about one inch below the top end of the stake and a second transverse aperture formed therein about two inches below the top end, the second transverse aperture contains a ring which is capable of holding a jerk line. It is contemplated that a plurality of transverse apertures can be drilled or formed within the stake to provide adjustable attachment of the decoy which are generally mounted onto a base with a tubular square shaped member which fits in cooperative relationship with the top end 316 of the rod. The transverse hole 318 near the tip 315 of the squared off end 316 is provided for insertion of a pin or keeper when the square hollow receiver 354 of the decoy 350 is installed on the squared end 316. Another transverse hole 319 contains a ring 320 for connection of a jerk line which a user may pull or jerk to cause the decoy stake to move. The crank handle 314 is located near the square end 316 whereby a user can loosely hold the squared end 316 in one hand and the crank handle 314 in the other hand while pressing the end of the helical coil 312 into the soil and can turn the crank handle 314 with respect to the square end 316 to cause the helical coil 312 to be threaded into the ground. The crank handle is formed by bending rod 311 ninety degrees about 5 inches below the top end to form a horizontal portion. About four inches past the first ninety degree bend, make a second ninety degree bend vertically downward. About four inches from the second ninety degree bend, make a third ninety degree bend so that the rod now forms a U shape. Finally, about four inches from the third ninety degree bend, bend rod 311 vertically downward so that the top portion of rod 311 above the U shape, is coaxial with the bottom portion of rod 311 below the U shape. After the stake 310 is screwed into the ground, the square hollow receiver 354 of a decoy 350 is slipped over the square end 316 of the stake 310. The hole 352 in receiver 354 is aligned with the hole 318 in the square end 316 of the stake 310, and a lynch pin , such as shown in lynch pin 340 is slipped through to lock the decoy 350 into place on the stake 310. Thus a jerk line may be attached to a ring, such as a D-ring extending through the aperture or the line may be threaded through an aperture. In an alternate embodiment, the decoy stake 330 is contains a three part shaft including two round rods 333 and 334 and a tube 336 into which the rods 333 and 334 are slipped. The transverse hole 331 in rod 333 is aligned with the transverse hole 337 in the tube 336 and a lynch pin 340 is inserted therein. Likewise, the transverse hole 335 in rod 334 is brought into alignment with the transverse hole 338 of tube 336 and a lynch pin 340 is inserted therein. Thus, the stake 330 can be used in the same way as the stake 310 is used. The disassembled three part shaft enables more compact storage of the stake 330 and also the capability of having and even longer assembled stake 330 depending on the size and number of rods and tubes. It also facilitates transport in a back pack, or case which will fit into a luggage compartment.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplification presented herein above. Rather, what is intended to be covered is within the spirit and scope of the appended claims.

I claim:

1. A decoy/camera stake comprising:
an elongated rod having a helical coil formed at a bottom end thereof and an integral S-shaped crank handle formed therein above said helical coil, a length of said rod being adjustable; and
said rod having a selected length of male threads at a top end thereof, said threads having a diameter of one quarter inch and a pitch of 20 threads per inch.

2. The decoy/camera stake described in claim 1 having a two part elongated rod, an upper part of said elongated rod having a vertical cylindrical void formed therein, said cylindrical void open at a bottom end thereof said upper part having a clamp and thumbscrew at the lower end thereof, a lower part of said elongated rod capable of sliding into said open cylindrical void and being held rigidly in place by said thumbscrew and said clamp.

3. The decoy/camera stake described in claim 1 having a two part elongated rod, an upper part of said elongated rod having a vertical cylindrical void formed therein, said cylindrical void open at a bottom end thereof said cylindrical void having a plurality of pairs of transverse apertures formed therein, said pairs of apertures one above another, a lower part of said elongated rod capable of sliding into said open cylindrical void, having a transverse aperture formed therein near and upper end thereof, and being held rigidly in place by a lynchpin inserted through said transverse aperture in said lower part when said transverse aperture in said lower part is aligned with a selected one of said plurality of pairs of transverse apertures in said upper part.

4. The decoy/camera stake described in claim 3 further including a fixable bal joint connecting said elongated rod to said threaded top end thereof
